(19) United States
(12) Patent Application Publication
(10) Pub. No.: US 2025/0348782 A1
(43) Pub. Date: Nov. 13, 2025

(54) FREQUENCY-DOMAIN MACHINE LEARNING MODEL ADAPTERS

(71) Applicant: QUALCOMM Incorporated, San Diego, CA (US)

(72) Inventors: Shubhankar Mangesh BORSE, San Diego, CA (US); Shreya KADAMBI, San Diego, CA (US); Kartikeya BHARDWAJ, San Diego, CA (US); Nilesh Prasad PANDEY, La Jolla, CA (US); Sweta PRIYADARSHI, San Diego, CA (US); Risheek GARREPALLI, San Diego, CA (US); Rafael Xavier ESTEVES, San Diego, CA (US); Munawar HAYAT, San Diego, CA (US); Fatih Murat PORIKLI, San Diego, CA (US)

(21) Appl. No.: 18/662,303

(22) Filed: May 13, 2024

(51) Int. Cl. G06N 20/00

(52) U.S. Cl. CPC G06N 20/00

(57) ABSTRACT

Certain aspects of the present disclosure provide techniques and apparatus for improved machine learning. In an example method, a first feature tensor is accessed as input to a portion of a machine learning model. A second feature tensor is generated based on processing the first feature tensor using the portion of the machine learning model, and a frequency tensor is generated based on processing the first feature tensor using a Fourier transform operation. A transformed frequency tensor is generated based on processing the frequency tensor using a trained adapter corresponding to the portion of the machine learning model. A third feature tensor is generated based on processing the transformed frequency tensor using an inverse Fourier transform operation. A fourth feature tensor is generated as output from the portion of the machine learning model based on aggregating the second and third feature tensors.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs) and/or large vison models (LVMs) to process and generate output data. Often, machine learning models (especially LLMs and LVMs) have many parameters (e.g., millions or even billions), resulting in significant model size, as well as substantial computational expense in training the model. Further, once trained, such models are often difficult (or impossible) to fine-tune, as the vast number of parameters makes overfitting a major challenge (e.g., potentially relying on tremendous amounts of fine-tuning data to prevent overfitting).

One recent approach to enable fine-tuning or personalization of such generative models involves training relatively smaller model adapters for larger models. However, in many cases, models coupled with personalized adapters can suffer from mode collapse, where the generated outputs are highly similar regardless of the input prompts. Further, models using personalized adapters are often heavily biased towards the characteristics reflected in the fine-tuning data that is used to train the adapter(s), resulting in substantially reduced diversity in the generated outputs.

### BRIEF SUMMARY

Certain aspects of the present disclosure provide a processor-implemented method, comprising: accessing a first feature tensor as input to a first portion of a machine learning model; generating a second feature tensor based on processing the first feature tensor using the first portion of the machine learning model; generating a first frequency tensor based on processing the first feature tensor using a Fourier transform operation; generating a first transformed frequency tensor based on processing the first frequency tensor using a first trained adapter corresponding to the first portion of the machine learning model; generating a third feature tensor based on processing the first transformed frequency tensor using an inverse Fourier transform operation; and generating a fourth feature tensor as output from the first portion of the machine learning model based on aggregating the second and third feature tensors.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example architecture for frequency-domain machine learning, according to some aspects of the present disclosure.

FIG. 2 depicts an example architecture for frequency-domain machine learning adapters, according to some aspects of the present disclosure.

FIG. 3 depicts an example workflow for training frequency mask components for frequency-domain machine learning, according to some aspects of the present disclosure.

FIG. 4 is a flow diagram depicting an example method for training frequency-domain machine learning model adapters, according to some aspects of the present disclosure.

FIG. 5 is a flow diagram depicting an example method for generating model output using frequency-domain model adapters, according to some aspects of the present disclosure.

FIG. 6 is a flow diagram depicting an example method for processing data using frequency-domain model adapters, according to some aspects of the present disclosure.

FIG. 7 is a flow diagram depicting an example method for frequency-domain model adapters, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

In some aspects of the present disclosure, low-rank adapter operations can be applied in the frequency domain, rather than in the spatial domain, to improve model performance. For example, in some aspects, low-rank adaptation (LoRA) adapters may be trained to operate in the frequency domain, which may improve generation diversity and prevent (or at least reduce) generation bias. In some aspects, these adapters may be referred to as frequency-domain low-rank adapters.

In some aspects, the adapter(s) may further mask one or more frequencies in the frequency domain (e.g., applying frequency masking). In some aspects, the adapters may be trained to learn which frequencies to mask. In some aspects, such masking can apply a regularization effect to the adapters in the frequency domain, which may ensure that the adapter layers learn to mask specific frequencies that correspond to various undesired characteristics (e.g., to prevent or reduce bias towards the adapter's training data). That is, optimization constraints may be imposed on the network such that the frequency masks are trained to remove (or reduce reliance on) the undesired characteristics of the training data. In some aspects, a distribution matching loss (e.g., maximum mean discrepancy (MMD) loss may be used to train the frequency masking components, as discussed in more detail below.

In some aspects, frequency-domain model adaptation can be used to improve merging of multiple adapters together, resulting in improved performance (e.g., improved output accuracy and/or quality) as compared to some conventional approaches to aggregate adapter outputs separately. In some aspects, these improvements in adapter merging may be a result of providing a basis for the frequency components to overlap, using the frequency-domain adaptation discussed in more detail below. That is, in some conventional approaches, the outputs of the adapters may not be additive, as the adapters are generally trained separately to modify the features themselves rather than to merge the outputs. However, in some aspects, frequency masking using frequency masks that are at least partially non-overlapping can allow for the output of each adapter to be combined more effectively.

Some conventional vision models exhibit substantial bias towards characteristics of the data used to train model adapters. For example, some conventional approaches result in model output that is heavily biased towards the poses reflected in the training data, (e.g., the particular way individuals are standing or seated in the training data), the colors reflected in the training data (e.g., the ethnicity of the individuals, or the coloring of the subject, such as if the color blue dominates in the training data), and the like. In some aspects, this bias may be attributed to the spatial pattern of activations in the feature maps that the model generates and operates on. These spatial patterns encode information about these attributes of the input image.

In some aspects, by operating on a frequency-domain representation of the input, the spatial patterns in the feature maps can be transformed into the frequency domain (e.g., by applying a Fourier transform). The resulting frequency components may represent the different spatial frequencies and orientations present in the original feature maps. In some aspects, certain frequency components may be more strongly associated with the undesired training data attributes than others. In some aspects, by selectively masking or attenuating these components, the system may substantially reduce the bias towards these attributes while preserving other relevant information in the feature maps.

As a result, the adapted machine learning model may generate substantially improved outputs that prevent or reduce mode collapse, improve generation diversity (e.g., such that generated outputs are more dissimilar from each other), and/or prevent or reduce bias towards adapter training data.

### Example Architecture for Frequency-Domain Machine Learning

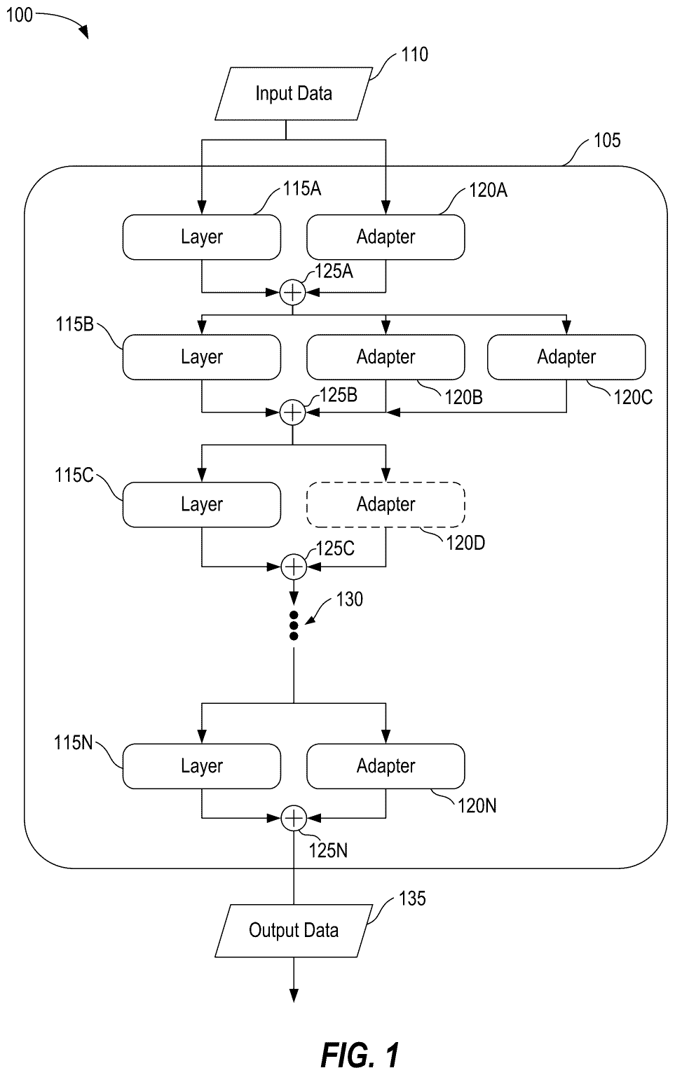

FIG. 1 depicts an example architecture 100 for frequency-domain machine learning, according to some aspects of the present disclosure.

In some aspects, the architecture 100 may be implemented or used by a computing system such as a machine learning system. As used herein, a machine learning system may generally refer to any computing system capable of performing the described operations, and may be implemented on a single device or across multiple systems using hardware, software, or a combination of hardware and software. In some aspects, the operations described herein may be distributed across multiple systems. For example, a first system may be used to train the machine learning model (e.g., to train a base model and/or model adapters) while a second system may be used to generate output using the trained model(s). In some aspects, these systems may be referred to as a “training system” and a “generation system,” respectively, or simply as “machine learning systems.”

In the illustrated architecture 100, input data 110 is accessed by a machine learning model 105 to generate output data 135. As used herein, “accessing” data may generally include receiving, requesting, retrieving, obtaining, generating, collecting, or otherwise gaining access to the data. For example, the input data 110 may be received from a user or other process or entity. Generally, the content and format of the input data 110 and the output data 135 may vary depending on the particular implementation. For example, in some aspects, the input data 110 may be a natural language description (e.g., natural language text) of desired model output, and the machine learning model 105 may be an LLM, LVM, or other generative model trained to generate the output data 135 in accordance with this description. For example, the input data 110 may specify “a lion surrounded by blue fire,” and the output data 135 may include or correspond to an image depicting a lion surrounded by blue fire.

In the illustrated example, the machine learning model 105 consists of one or more components of a base machine learning model (e.g., the layers 115A-N) as well as one or more adapters 120A-N (referred to in some aspects as adapter models). For example, as discussed above, the layers 115A-N may correspond to an LLM, LVM, or other generative model, and the adapters 120A-N may correspond to LoRA adapters.

As illustrated, the input data 110 is processed by a first layer 115A (or other component or portion of the base model), as well as a first adapter 120A. The resulting output from the layer 115A (e.g., a first feature tensor generated by the layer 115A) is then aggregated with the output of the adapter 120A (e.g., a second feature tensor) using operation 125A. For example, the operation 125A may include elementwise summation, concatenation, and the like.

In the illustrated example, the resulting aggregated feature tensor is then accessed by the next portion of the base model (e.g., the layer 115B) as well as a set of adapters 120B and 120C that correspond to the layer 115B. The outputs of each of these components are similarly aggregated using the operation 125B, and the aggregated tensor is provided as input to the layer 115C and the adapter 120D. The feature tensors generated by the layer 115C and the adapter 120D are aggregated via the operation 125C. As indicated by the ellipses 130, there may be any number of layers (or other components) of the machine learning model 105.

As illustrated, a feature tensor generated by the penultimate component(s) of the machine learning model 105 (e.g., the penultimate layer and/or adapter(s)) is then accessed by the final layer 115N and the corresponding adapter 120N. The feature tensors generated by the final layer 115N and the adapter 120N are then aggregated via the operation 125N, and the resulting output data 135 is output from the machine learning model 105.

Although the illustrated example depicts an adapter 120N for each layer of the base model (including the first layer 115A and the final layer 115N), in some aspects, one or more components of the base model may lack a corresponding adapter. For example, as indicated by the dashed lines used to depict the adapter 120D, the layer 115C may not have a corresponding adapter. Further, in some aspects, some layers (such as the layer 115B) may have multiple adapters 120 (e.g., adapters 120B and 120C). The illustrated architecture 100 is generally depicted for conceptual clarity, and the particular architecture used may vary depending on the given implementation. That is, each layer 115 (or other portion or component of the base model) may generally have zero or more corresponding adapters 120, where an adapter 120 is referred to as “corresponding to” a base model component when the adapter 120 and base model component operate on the same input data (e.g., the same feature tensor) and the outputs of the adapter and base model component are aggregated (e.g., by an operation 125). Generally, each layer 115 may be executed in sequence or in parallel with the corresponding adapter(s) 120.

In some aspects, as discussed above, one or more of the adapters 120 may be frequency-domain adapters. That is, one or more of the adapters 120 may operate on the input data in the frequency domain, rather than in the spatial domain, as discussed in more detail below. For example, the input feature tensor to each adapter 120 may be processed using a Fourier transform operation to convert the feature tensor to the frequency domain (from the spatial domain), and the adapters 120 may process these frequency-domain tensors. The output of each adapter 120 may then be processed using an inverse Fourier transform operation to return the features to the spatial domain, allowing the output of each adapter 120 to be aggregated effectively with the output of the corresponding layer 115.

As discussed above, operating in the frequency domain can substantially improve the performance of the model. For example, training the adapters 120 to operate in the frequency domain may improve generative diversity and prevent or reduce mode collapse. As another example, frequency masking in the frequency domain may reduce or eliminate generative bias, resulting in improved output data 135.

### Example Architecture for Frequency-Domain Machine Learning Adapters

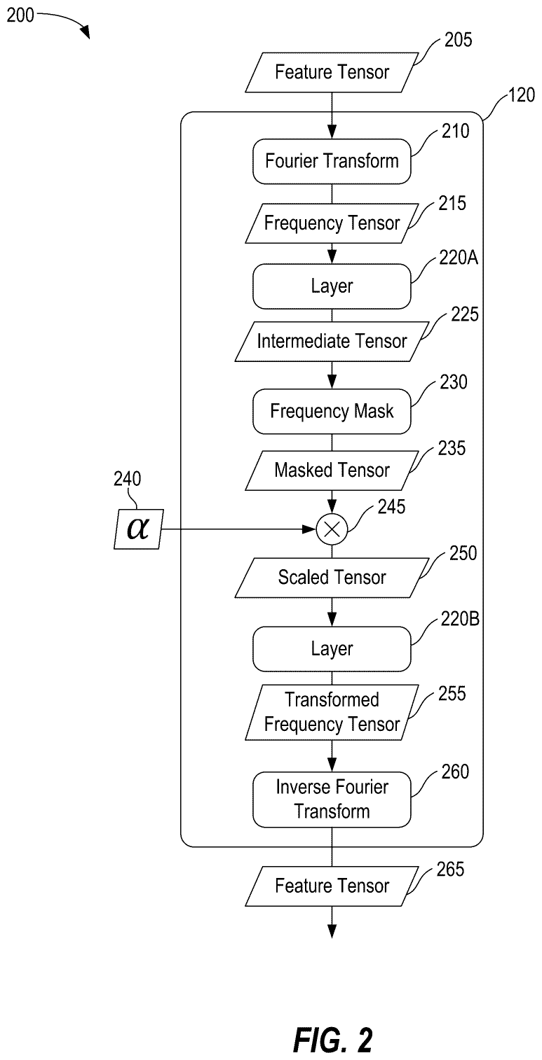

FIG. 2 depicts an example architecture 200 for frequency-domain machine learning adapters, according to some aspects of the present disclosure. In some aspects, the architecture 200 may be implemented or used by a computing system such as a machine learning system (e.g., the machine learning system discussed above with reference to FIG. 1. In the illustrated example, the architecture 200 gives additional detail for an adapter 120 from FIG. 1.

As illustrated, the adapter 120 accesses an input feature tensor 205 (e.g., from an aggregation operation such as one of the operations 125 of FIG. 1 and/or from a component of the base model, such as a layer 115 of FIG. 1) and generates an output feature tensor 265 (e.g., where the output feature tensor 265 is provided to an aggregation operation to be combined with a feature tensor generated by the base model portion that corresponds to the adapter 120). The illustrated architecture 200 generally includes a sequence of components used to process the feature tensor 205. However, the particular components (as well as the arrangement of such components) may vary depending on the particular implementation.

In the illustrated example, the feature tensor 205 is first processed using a Fourier transform 210 (e.g., a fast Fourier transform (FFT)), sometimes referred to as a Fourier transform operation, to generate a frequency tensor 215. As discussed above, the frequency tensor 215 generally represents the features of the feature tensor 205 in the frequency domain, as compared to the spatial domain of the feature tensor 205.

As illustrated, the frequency tensor 215 may be processed using a layer 220A to generate an intermediate tensor 225. The layer 220A (which may correspond to multiple layers or components) may generally perform a variety of operations to generate the intermediate tensor 225. In some aspects, the layer 220A performs a dimensionality and/or rank reduction or downsampling operation to the frequency tensor 215. For example, if the input feature tensor 205 and the frequency tensor 215 have a first dimensionality (e.g., C×D₁), the layer 220A may downsample the frequency tensor 215 to generate an intermediate tensor 225 having a lower dimensionality or rank (e.g., (C×R), where R is less than D₁). In some aspects, the dimensionality of the intermediate tensor 225 may be substantially reduced (e.g., R may be much smaller than D₁). Using a low rank (e.g., in a LoRA adapter) for the intermediate tensor 225 may improve model performance in a variety of ways, such as by reducing training expense and latency, reducing overfitting, and the like. Although two-dimensional tensors are discussed for conceptual clarity, the adapter 120 may be trained to operate on tensors with any number of dimensions (where the rank of the intermediate tensor 225 is less than the rank of the frequency tensor 215). In some aspects, the layer 220A is a linear layer that reduces the rank of the frequency tensor 215.

In the illustrated workflow, the intermediate tensor 225 is then processed by a frequency mask component 230 to generate a masked tensor 235. The frequency mask component 230 may generally be a component trained to generate frequency masks and mask the input intermediate tensor 225 based on the frequency mask. In some aspects, the frequency mask component 230 generates the frequency mask based at least in part on the feature tensor 205. For example, the frequency mask component 230 may process the intermediate tensor 225 using one or more layers (e.g., linear layers followed by a sigmoid operation or other activation function) to generate the frequency mask. The frequency mask may generally be a tensor having the same size of the intermediate tensor 225. In some aspects, the frequency mask includes values between zero and one (e.g., to adjust the amount that each element of the intermediate tensor 225 is attenuated). In some aspects, the frequency mask includes binary values (e.g., to either completely mask or refrain from modifying each element). For example, the frequency mask may be multiplied with the intermediate tensor 225 to generate the masked tensor 235.

In the illustrated example, the masked tensor 235 can then be processed by an operation 245. The operation 245 also receives, as input, an adapter weight 240 (denoted as alpha in the illustrated example). The adapter weight 240 (also referred to in some aspects as a scale) may generally be used to define the amount of contribution of the adapter 120, as compared to the base model. For example, higher values for the adapter weight 240 may result in more influence from the adapter 120, while lower values may reduce the impact of the adapter 120. In some aspects, the adapter weight 240 may be implemented as a hyperparameter (e.g., specified by the user). The adapter weight 240 may be the same for all adapters or layers of the model, or may differ across layers.

In some aspects, the operation 245 corresponds to a multiplication operation, where each value of the masked tensor 235 is multiplied by the adapter weight 240 (or is otherwise scaled based on the adapter weight 240, such as if the adapter weight 240 is normalized to a value between zero and one). As illustrated, the operation 245 results in a scaled tensor 250.

In the illustrated example, the scaled tensor 250 is processed using another layer 220B (e.g., one or more linear layers) to generate a transformed frequency tensor 255. The layer 220B may generally perform a dimensionality increase or upsampling operation to the scaled tensor 250. For example, if the scaled tensor 250 has dimensionality C×R), the layer 220B may upsample the scaled tensor 250 to generate the transformed frequency tensor 255 having a higher dimensionality or rank (e.g., (C×D₂), where R is less than D₂ and D₂ may or may not equal D₁). In some aspects, the dimensionality of the transformed frequency tensor 255 may be substantially increased (e.g., R may be much smaller than D₂).

In the illustrated example, the transformed frequency tensor 255 can then be processed using an inverse Fourier transform 260 (e.g., an inverse FFT (IFFT)), sometimes referred to as an inverse Fourier transform operation, to generate the feature tensor 265. As discussed above, the feature tensor 265 is used as the output from the adapter 120 (e.g., to be aggregated with the output of the corresponding portion of the base model).

As discussed above, by performing in the frequency domain and/or by using frequency masking, the adapter 120 may substantially improve the performance and output of the machine learning model.

### Example Workflow for Training Frequency Mask Components for Frequency-Domain Machine Learning

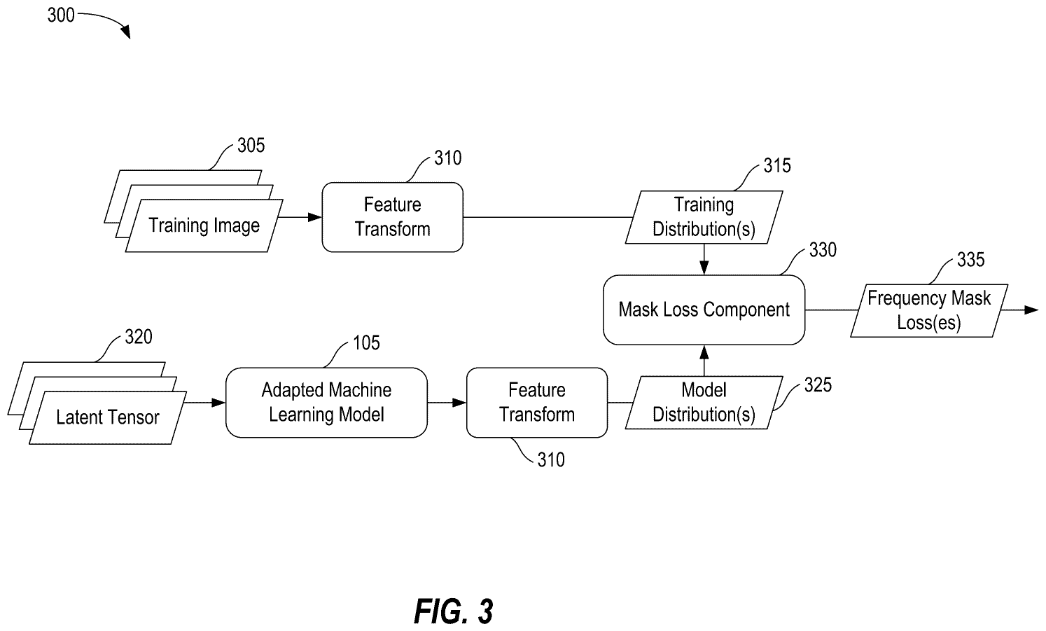

FIG. 3 depicts an example workflow 300 for training frequency mask components for frequency-domain machine learning, according to some aspects of the present disclosure. In some aspects, the workflow 300 may be implemented or used by a computing system such as a machine learning system (e.g., the machine learning system discussed above with reference to FIGS. 1 and/or 2). In the illustrated example, the workflow 300 gives additional detail for training a frequency mask component, such as the frequency mask component 230 of FIG. 2.

In the illustrated example, a set of training images 305 as processed by a feature transform 310 to generate a set of training distribution(s) 315. In some aspects, the feature transform 310 generally corresponds to a trained encoder (e.g., a neural network) that transforms the training images 305 to latent representations. In some aspects, the feature transform 310 can add noise iteratively (e.g., where the output of a first application results in a training image 305 with relatively little noise, processing this noisy training image again adds additional noise, and so on). In some aspects, the feature transform 310 is also used while training the adapters (e.g., the adapters 120 of FIGS. 1-2). That is, the feature transform 310 may be used to transform and/or add noise to the training images 305, allowing the noisy images to be used as target output for each iteration or application of the machine learning model.

For example, if the base model is a pre-trained generative model trained to iteratively generate output (e.g., generated images) over twenty iterations or applications, the feature transform 310 may be used to generate nineteen noisy latent versions of each training image 305 (each progressively more noisy than the last). During the first iteration, the noisiest images are used, and during the final iteration, the original training image 305 can be used. This process can be used to iteratively train the adapter(s) to assist in the de-noising (e.g., image generation) process based on the training images 305. In some aspects, as discussed above, the base model parameters may be pre-trained and frozen during the process of training the adapter(s). In some aspects, the workflow 300 can then be performed after the adapter(s) are trained in order to train the frequency mask generation components. For example, the adapter parameters (e.g., the parameters of the layers 220 of FIG. 2) may be frozen, allowing the parameters of the frequency mask model to be trained.

In the illustrated example, the training distribution(s) 315 generally correspond to distributions of the noisy training images 305 at each iteration. That is, the feature transform 310 may generate a respective training distribution 315 for each respective iteration or application of the model during runtime. In some aspects, for example, the training distributions 315 may indicate the distribution of pixel values in the training images 305 after the corresponding amount of noise has been added. As illustrated, the training distributions 315 are provided to a mask loss component 330, discussed in more detail below.

In the workflow 300, a set of latent tensors 320 are processed by the adapted machine learning model 105 (e.g., a base model and one or more trained adapters) to generate input to another feature transform 310, which generates model distributions 325. In some aspects, the latent tensors 320 generally comprise random (e.g., Gaussian) noise. In some aspects, during runtime, the latent tensors 320 are used to begin the generation process (guided by the base model and adapters), which, as discussed above, may comprise an iterative denoising operation to generate model output (e.g., denoised images reflecting the input prompt).

In some aspects, the machine learning model 105 generates the data used as input to the feature transform 310 by processing the latent tensor 320 using the label(s) (e.g., natural language text) associated with the training image(s) 305. For example, the latent tensor 320 may be used as input along with a description such as “a lion surrounded by blue fire,” where the corresponding training image 305 depicts a lion surrounded by blue fire. By comparing the denoised output of the model to the (noisy) version of the training image 305 across iterations, the adapters can be trained, as discussed above. Further, once the adapters are so trained, the workflow 300 can be used to train the mask components.

Specifically, in the illustrated example, the model distributions 325 generally correspond to distributions of the (partially) denoised latent tensors at each iteration. That is, the adapted machine learning model 105 may generate a respective model distribution 325 for each respective iteration or application of the model during runtime. In some aspects, for example, the model distributions 325 may indicate the distribution of pixel values in the partially denoised images after the corresponding amount of noise has been added. As illustrated, the model distributions 325 are also provided to the mask loss component 330.

As illustrated, the mask loss component 330 processes the training distributions 315 (corresponding to noisy versions of the training images 305) and the model distributions 325 (corresponding to partially denoised images generated from latent tensors 320 based on input prompts) to generate frequency mask loss(es) 335 (e.g., a respective frequency mask loss 335 for each iteration that the model performs during runtime).

Generally, the mask loss component 330 may use a variety of loss formulations depending on the particular implementation. In some aspects, the mask loss component 330 generates frequency mask loss(es) 335 to attempt to cause the training distributions 315 and the model distributions 325 to diverge. For example, the mask loss component 330 may use an MMD loss formulation. The frequency mask losses 335 can then be used to update the parameters of the frequency mask generation model(s), pushing the mask generators to generate frequency masks that result in images which differ from each other. This can improve generation diversity, reduce mode collapse, and reduce bias towards the training images 305.

Although the illustrated example depicts one workflow 300 for learning to generate improved frequency masks, in some aspects, one or more other techniques may be used in addition to or instead of the depicted learned approach. In some aspects, the frequency mask generator is generally trained to mask frequencies correlated with mode collapse in the model output (e.g., frequencies correlated with reductions in generation diversity and/or bias towards the adapter training data). For example, in some aspects, the machine learning system may use techniques such as gradient-weighted class activation mapping (Grad-CAM) to generate maps highlighting important regions or portions in the input data for predicting the corresponding undesired concepts (e.g., pose, style, ethnicity, and the like). The machine learning system may then update the frequency mask components to mask or attenuate these undesired frequencies.

As another example, the machine learning system may perturb, attenuate, or mask various frequencies experimentally (e.g., masking one or more different frequencies during different experiments) to determine which frequencies most impact or communicate the undesired attributes (e.g., which frequencies, when masked, most eliminate the bias towards characteristics such as pose, color, style, and the like). The machine learning system can then update the mask generation component to target these determined frequencies.

Advantageously, by learning to generate frequency masks, the machine learning system can substantially reduce mode collapse and generation bias, improving output diversity and generally improving the operations of the machine learning model.

### Example Method for Training Frequency-Domain Machine Learning Model Adapters

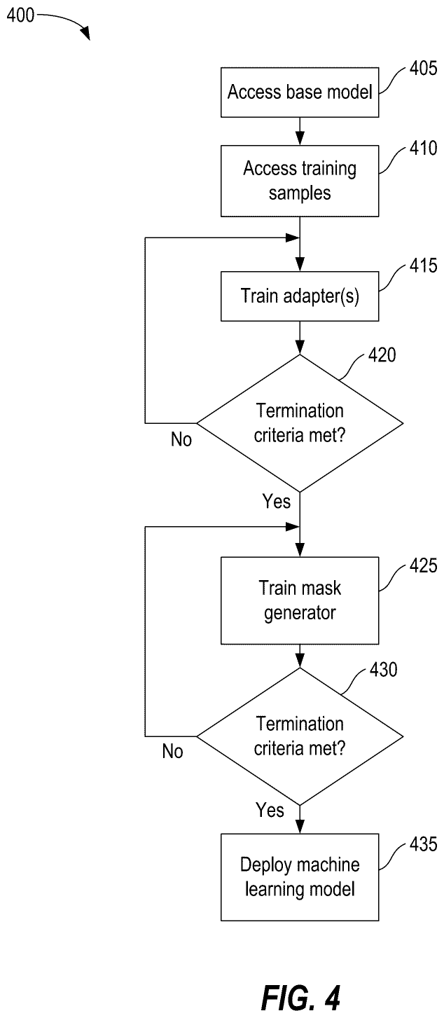

FIG. 4 is a flow diagram depicting an example method for training frequency-domain machine learning model adapters, according to some aspects of the present disclosure. In some aspects, the method 400 may be implemented or used by a computing system such as a machine learning system (e.g., the machine learning system discussed above with reference to FIGS. 1 2, and/or 3).

At block 405, the machine learning system accesses a base machine learning model (e.g., the layers 115 of FIG. 1). In some aspects, as discussed above, the base machine learning model is a generative model trained to generate output (e.g., text, video, images, audio, and the like) based on input (e.g., natural language descriptions of the desired output). For example, the base model may correspond to or comprise an LLM, an LVM, and the like. In some aspects, the base model may be pre-trained (e.g., by the machine learning system or by another system) to generate output. As discussed above and in more detail below, the machine learning system may then train one or more adapter models to personalize, fine-tune, or otherwise modify the output of the base model (e.g., for specific tasks, users, domains, and the like).

At block 410, the machine learning system accesses a set of training samples (e.g., the training images 305 of FIG. 3). In some aspects, as discussed above, the training samples may generally correspond to a (relatively small) set of images for the target domain (e.g., for a specific user or task for which the base model is being adapted). In some aspects, as discussed above, each sample in the training samples may include a corresponding input prompt (e.g., a textual description of the sample).

At block 415, the machine learning system trains one or more adapter(s) (e.g., the adapters 120 of FIGS. 1-2) based on the training sample(s). For example, as discussed above, the machine learning system may generate an output based on a prompt of one training sample, and compare the output to the training sample itself to generate a loss. These losses for each training sample can be used to refine the adapter parameters in order to improve the model output. In some aspects, as discussed above, the machine learning system may generate losses at multiple generation stage or iteration for each training sample.

At block 420, the machine learning system determines whether one or more termination criteria are met. Generally, the particular adapter training termination criteria may vary depending on the particular implementation. For example, in some aspects, the machine learning system may determine whether a defined number of training iterations or epochs have been applied, whether a defined amount of computing resources have been spent, whether a defined length of time has passed, whether the model accuracy has reached a desired level, and the like.

If the termination criteria are not met, the method 400 returns to block 415 to continue training the adapter(s). If, at block 420, the machine learning system determines that the adapter training criteria are satisfied, the method 400 continues to block 425. At block 425, the machine learning system trains one or more mask generator models based on the training samples, as discussed above. For example, the machine learning system may freeze the parameters of the adapters (refraining from further updating to the adapters) and use the workflow 300 of FIG. 3 to update the parameters of the mask generation component(s). In some aspects, while training the adapters, the machine learning system may use random frequency masking, may refrain from any frequency masking, and the like. Once the adapters are trained, the frequency mask generators can then be trained based on the trained adapters.

At block 430, the machine learning system determines whether one or more frequency mask training termination criteria are met. Generally, the particular mask training termination criteria may vary depending on the particular implementation. For example, in some aspects, the machine learning system may determine whether a defined number of training iterations or epochs have been applied, whether a defined amount of computing resources have been spent, whether a defined length of time has passed, whether the model accuracy or diversity has reached a desired level, and the like.

If, at block 430, the machine learning system determines that the criteria are not met, the method 400 returns to block 425 to continue training the mask generator(s). If, at block 430, the machine learning system determines that the termination criteria are met, the method 400 continues to block 435. At block 435, the machine learning system deploys the adapted machine learning model (e.g., the base model, the adapters, and the frequency masking components). Generally, “deploying” the model may include a variety of operations, and generally refers to any operations used to prepare or provide the model for runtime use (e.g., inferencing) to generate output. For example, the machine learning system may generate a data structure containing the learned parameters, transmit the model to one or more other systems for runtime use, instantiate the model locally (e.g., load the model into memory to be used), and the like.

### Example Method for Generating Model Output Using Frequency-Domain Model Adapters

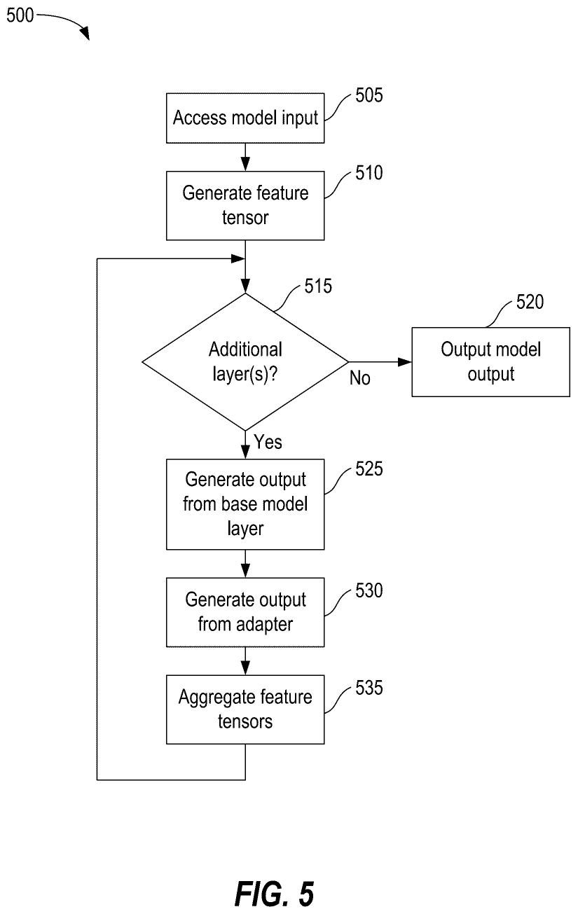

FIG. 5 is a flow diagram depicting an example method 500 for generating model output using frequency-domain model adapters, according to some aspects of the present disclosure. In some aspects, the method 500 may be implemented or used by a computing system such as a machine learning system (e.g., the machine learning system discussed above with reference to FIGS. 1 2, 3, and/or 4).

At block 505, the machine learning system accesses an input to an adapted machine learning model. For example, as discussed above, the input may include a textual description of the desired model output. In some aspects, the input may similarly include a base image or other data to seed the generation process.

At block 510, the machine learning system generates a feature tensor based on the model input. For example, the machine learning system may use one or more initial layers of the adapted machine learning model to perform feature extraction or any other preprocessing operations to prepare the input for processing using the remaining portions of the model.

At block 515, the machine learning system determines whether there is at least one additional layer (or other component) of the machine learning model remaining to be executed. For example, the machine learning system may determine whether there is at least one more layer, such as the layers 115 of FIG. 1, remaining. If so, the method 500 continues to block 525, where the machine learning system generates an output (e.g., a feature tensor) from the next base model layer based on the current feature tensor.

Further, at block 530, the machine learning system generates an output (e.g., a feature tensor, such as the feature tensor 265 of FIG. 2) from the adapter that corresponds to the next base model layer, as discussed above, based on the feature tensor (e.g., the feature tensor 205 of FIG. 2). Although the illustrated example suggests that each layer has an adapter, in some aspects, one or more of the layers may not have such an adapter, as discussed above. Further, in some aspects, one or more of the layers may have multiple adapters.

At block 535, the machine learning system aggregates the feature tensors (e.g., the output of the portion of the base model, as well as the output(s) of the corresponding adapter(s)). For example, as discussed above, the machine learning system may perform an element-wise summation (e.g., using the operations 125 of FIG. 1) to aggregate the feature tensors. The method 500 then returns to block 515, where the machine learning system again determines whether there is at least one additional layer of the model. If so, the aggregated tensor (generated at block 535) can be used as input to the next layer. If not, the method 500 proceeds to block 520.

At block 520, the machine learning system outputs the model output (e.g., the output of the last layer of the model). For example, the machine learning system may provide the output to a requesting entity (e.g., a user), display the output on a screen or other display device, and the like.

### Example Method for Processing Data Using Frequency-Domain Model Adapters

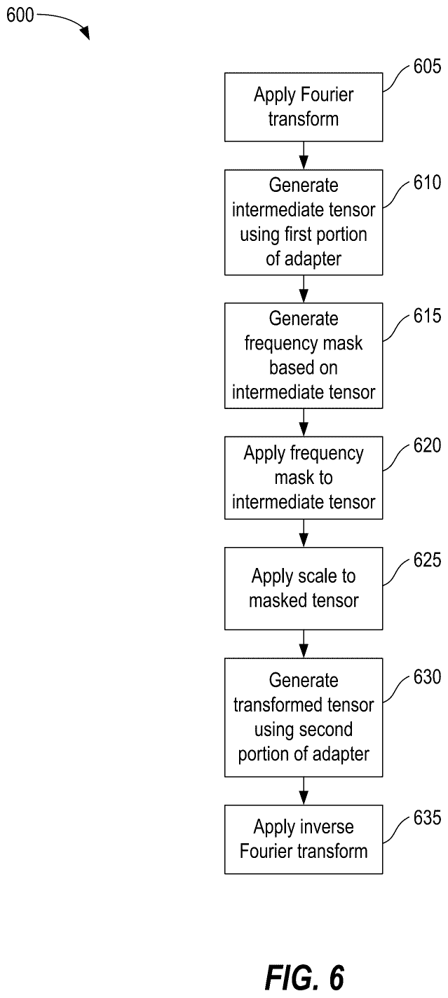

FIG. 6 is a flow diagram depicting an example method 600 for processing data using frequency-domain model adapters, according to some aspects of the present disclosure. In some aspects, the method 600 may be implemented or used by a computing system such as a machine learning system (e.g., the machine learning system discussed above with reference to FIGS. 1 2, 3, 4, and/or 5). In some aspects, the method 600 provides additional detail for block 530 of FIG. 5.

At block 605, the machine learning system applies a Fourier transform operation (e.g., the Fourier transform 210 of FIG. 2) to the input feature tensor of the adapter (e.g., the feature tensor 205 of FIG. 2). In some aspects, as discussed above, the Fourier transform operation transforms the input feature tensor from the spatial domain to the frequency domain (e.g., to generate the frequency tensor 215 of FIG. 2).

At block 610, the machine learning system can generate an intermediate tensor (e.g., the intermediate tensor 225 of FIG. 2) using a first portion of the adapter. For example, the machine learning system may process the frequency tensor using one or more linear layers trained to, among other things, reduce the rank of the input (e.g., the layer 220A of FIG. 2).

At block 615, the machine learning system generates a frequency mask based on the intermediate tensor. For example, as discussed above, the machine learning system may process the intermediate tensor using a frequency mask generation model (e.g., the frequency mask component 230 of FIG. 2) to generate the frequency mask. As discussed above, the frequency mask may generally have the same size or dimensionality of the intermediate tensor, where each value in the frequency mask indicates the amount (if any) to attenuate or mask the corresponding element of the intermediate tensor.

At block 620, the machine learning system applies the generated frequency mask to the intermediate tensor (e.g., using an element-wise multiplication operation) to generate a masked tensor (e.g., the masked tensor 235 of FIG. 2).

At block 625, the machine learning system can apply a scale (also referred to as an adapter scale and/or an adapter weight), such as the adapter weight 240 of FIG. 2, to the masked tensor. For example, the machine learning system may multiply the scale with each element of the masked tensor (e.g., using the operation 245 of FIG. 2) to generate a scaled tensor (e.g., the scaled tensor 250 of FIG. 2).

At block 630, the machine learning system generates a transformed tensor (e.g., the transformed frequency tensor 255 of FIG. 2) based on processing the scaled tensor using a second portion of the adapter. For example, the machine learning system may process the scaled tensor using one or more linear layers trained to, among other things, increase the rank of the input (e.g., the layer 220B of FIG. 2) to match the dimensionality, rank, and/or size of the feature tensor generated by the corresponding base layer.

At block 635, the machine learning system applies an inverse Fourier transform operation (e.g., the inverse Fourier transform 260 of FIG. 2) to generate an output feature tensor (e.g., the feature tensor 265 of FIG. 2) for the adapter. As discussed above, the inverse Fourier transform generally converts the transformed tensor from the frequency domain to the spatial domain, allowing the output feature tensor to be additively aggregated with the feature tensor of the corresponding portion of the base model (as well as the output of other corresponding adapters, if any).

In this way, as discussed above, the machine learning system can generate substantially improved model output using frequency-domain processing and frequency masking to reduce mode collapse, improve generative diversity, and reduce generation bias.

### Example Method for Frequency-Domain Model Adapters

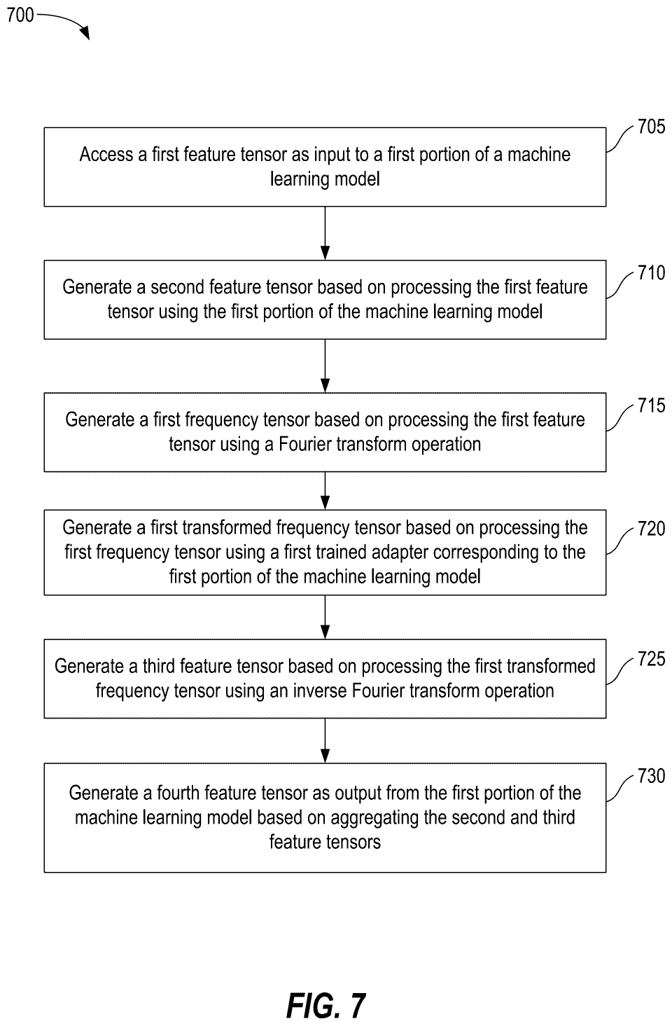

FIG. 7 is a flow diagram depicting an example method 700 for frequency-domain model adapters, according to some aspects of the present disclosure. In some aspects, the method 700 may be implemented or used by a computing system such as a machine learning system (e.g., the machine learning system discussed above with reference to FIGS. 1, 2, 3, 4, 5, 6, and/or 7).

At block 705, a first feature tensor is accessed as input to a first portion of a machine learning model.

At block 710, a second feature tensor is generated based on processing the first feature tensor using the first portion of the machine learning model.

At block 715, a first frequency tensor is generated based on processing the first feature tensor using a Fourier transform operation.

At block 720, a first transformed frequency tensor is generated based on processing the first frequency tensor using a first trained adapter corresponding to the first portion of the machine learning model.

At block 725, a third feature tensor is generated based on processing the first transformed frequency tensor using an inverse Fourier transform operation.

At block 730, a fourth feature tensor is generated as output from the first portion of the machine learning model based on aggregating the second and third feature tensors.

In some aspects, the method 700 further includes generating a second frequency tensor based on processing the first feature tensor using the Fourier transform operation, generating a second transformed frequency tensor based on processing the second frequency tensor using a second trained adapter corresponding to the first portion of the machine learning model, generating a fifth feature tensor based on processing the second transformed frequency tensor using the inverse Fourier transform operation, and generating the fourth feature tensor based further on the fifth feature tensor.

In some aspects, the method 700 further includes generating a fifth feature tensor based on processing the fourth feature tensor using a second portion of the machine learning model, generating a second frequency tensor based on processing the fifth feature tensor using the Fourier transform operation, generating a second transformed frequency tensor based on processing the second frequency tensor using a second trained adapter corresponding to the second portion of the machine learning model, generating a sixth feature tensor based on processing the second transformed frequency tensor using the inverse Fourier transform operation, and generating a seventh feature tensor as output from the second portion of the machine learning model based on aggregating the fifth and sixth feature tensors.

In some aspects, the trained adapter comprises a frequency mask generator.

In some aspects, the method 700 further includes generating a frequency mask, using the frequency mask generator, based on the first frequency tensor and generating the first transformed frequency tensor based on the frequency mask.

In some aspects, generating the first transformed frequency tensor includes generating an intermediate tensor based on processing the first frequency tensor using a first portion of the first trained adapter, generating the frequency mask based on processing the intermediate tensor using the frequency mask generator, applying the frequency mask to the intermediate tensor to generate a masked intermediate tensor, and generating the first transformed frequency tensor based on processing the masked intermediate tensor using a second portion of the first trained adapter.

In some aspects, the method 700 further includes applying an adapter weight to the intermediate tensor.

In some aspects, the frequency mask generator was trained to mask frequencies correlated with mode collapse in model output.

In some aspects, the first trained adapter comprises a frequency-domain low-rank adapter.

In some aspects, the method 700 further includes generating a model output based on the fourth feature tensor, wherein the model output comprises image data.

### Example Processing System for Machine Learning

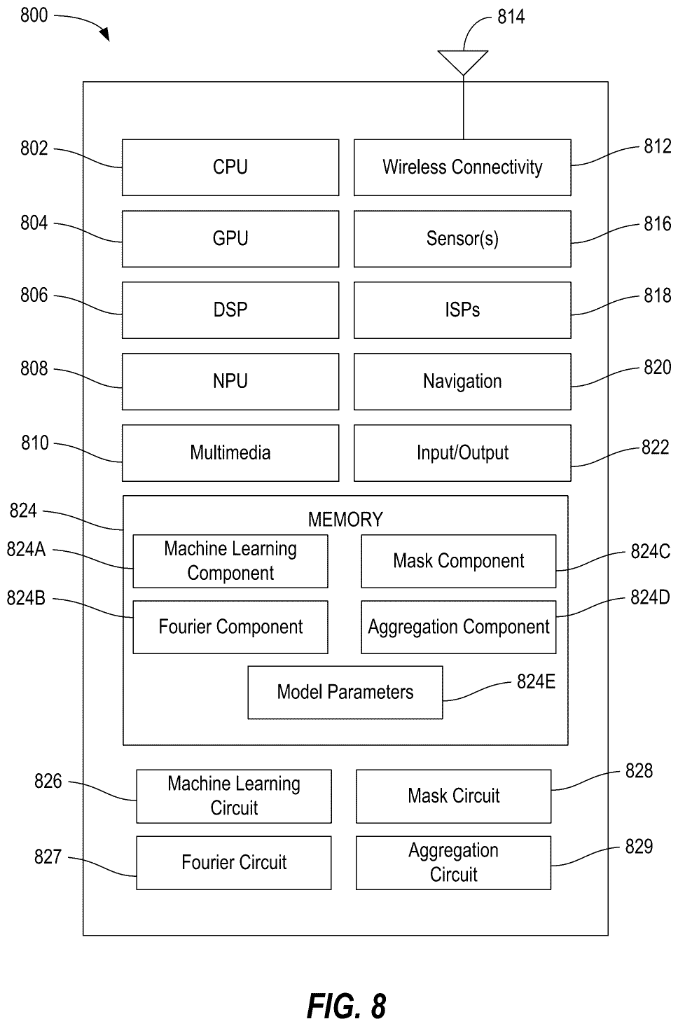

FIG. 8 depicts an example processing system 800 configured to perform various aspects of the present disclosure, including, for example, the techniques and methods described with respect to FIGS. 1-7. In some aspects, the processing system 800 may correspond to a machine learning system. For example, the processing system 800 may correspond to the machine learning system discussed above with reference to FIGS. 1-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a machine learning component 824A, a Fourier component 824B, a mask component 824C, and an aggregation component 824D. Although not depicted in the illustrated example, the memory 824 may also include other components, such as an inferencing or generation component to manage the generation of output predictions using trained machine learning models, a training component used to train or update the machine learning model(s), and the like. Though depicted as discrete components for conceptual clarity in FIG. 8, the illustrated components (and others not depicted) may be collectively or individually implemented in various aspects.

As illustrated, the memory 824 also includes a set of model parameters 824E (e.g., parameters of one or more machine learning models, such as weights and/or biases, used to generate model output). For example, as discussed above, the model parameters 824E may include pre-trained parameters for a base model, learned parameters for one or more adapters, learned parameters for one or more mask generators, and the like. Although not depicted in the illustrated example, the memory 824 may also include other data such as training data.

The processing system 800 further comprises a machine learning circuit 826, a Fourier circuit 827, a mask circuit 828, and an aggregation circuit 829. The depicted circuits, and others not depicted (such as an inferencing circuit), may be configured to perform various aspects of the techniques described herein.

The machine learning component 824A and/or the machine learning circuit 826 (which may correspond to the layers 115 of FIG. 1, the layers 220 of FIG. 2, and the like) may be used to generate and transform feature tensors based on trained parameters, as discussed above. For example, the machine learning component 824A and/or the machine learning circuit 826 may generate feature tensors based on trained parameters for the base model (e.g., for each layer 115 of FIG. 1) and/or generate tensors using trained portions of the adapters (e.g., the layers 220 of FIG. 2).

The Fourier component 824B and/or the Fourier circuit 827 (which may correspond to the Fourier transform 210 and/or the inverse Fourier transform 260 of FIG. 2) may be used to apply Fourier transform operations and/or inverse Fourier transform operations, as discussed above. For example, the Fourier component 824B and/or the Fourier circuit 827 may use FFT and/or IFFT operations to convert spatial tensors (e.g., feature tensors) to the frequency domain and to convert frequency tensors to the spatial domain, respectively, to allow the model adapters to operate in the frequency domain.

The mask component 824C and/or the mask circuit 828 (which may correspond to the frequency mask component 230 of FIG. 2) may be used to generate and apply frequency masks to tensors, as discussed above. For example, the mask component 824C and/or the mask circuit 828 may generate frequency masks based on processing input tensors (e.g., the intermediate tensor 225 and/or the scaled tensor 250, each of FIG. 2) using a trained frequency mask generator model, and may apply these masks to the scaled tensors to generate masked tensors (e.g., the masked tensor 235 of FIG. 2).

The aggregation component 824D and/or the aggregation circuit 829 (which may correspond to the operations 125 of FIG. 1) may be used to aggregate feature tensors, as discussed above. For example, the aggregation component 824D and/or the aggregation circuit 829 may perform element-wise summation to aggregate the feature tensor output by a given portion of the base model (e.g., a layer 115 of FIG. 1) with the feature tensor output by a corresponding adapter (e.g., an adapter 120 of FIG. 2). This aggregated feature tensor can then be provided as input to the subsequent component(s) of the model.

Though depicted as separate components and circuits for clarity in FIG. 8, the machine learning circuit 826, the Fourier circuit 827, the mask circuit 828, and the aggregation circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 maybe distributed between multiple devices.

### Example Clauses

Implementation examples are described in the following numbered clauses:

Clause 1: A method, comprising: accessing a first feature tensor as input to a first portion of a machine learning model; generating a second feature tensor based on processing the first feature tensor using the first portion of the machine learning model; generating a first frequency tensor based on processing the first feature tensor using a Fourier transform operation; generating a first transformed frequency tensor based on processing the first frequency tensor using a first trained adapter corresponding to the first portion of the machine learning model; generating a third feature tensor based on processing the first transformed frequency tensor using an inverse Fourier transform operation; and generating a fourth feature tensor as output from the first portion of the machine learning model based on aggregating the second and third feature tensors.

Clause 2: A method according to Clause 1, further comprising: generating a second frequency tensor based on processing the first feature tensor using the Fourier transform operation; generating a second transformed frequency tensor based on processing the second frequency tensor using a second trained adapter corresponding to the first portion of the machine learning model; generating a fifth feature tensor based on processing the second transformed frequency tensor using the inverse Fourier transform operation; and generating the fourth feature tensor based further on the fifth feature tensor.

Clause 3: A method according to any of Clauses 1-2, further comprising: generating a fifth feature tensor based on processing the fourth feature tensor using a second portion of the machine learning model; generating a second frequency tensor based on processing the fifth feature tensor using the Fourier transform operation; generating a second transformed frequency tensor based on processing the second frequency tensor using a second trained adapter corresponding to the second portion of the machine learning model; generating a sixth feature tensor based on processing the second transformed frequency tensor using the inverse Fourier transform operation; and generating a seventh feature tensor as output from the second portion of the machine learning model based on aggregating the fifth and sixth feature tensors.

Clause 4: A method according to any of Clauses 1-3, wherein the trained adapter comprises a frequency mask generator.

Clause 5: A method according to Clause 4, further comprising: generating a frequency mask, using the frequency mask generator, based on the first frequency tensor; and generating the first transformed frequency tensor based on the frequency mask.

Clause 6: A method according to Clause 5, wherein generating the first transformed frequency tensor comprises: generating an intermediate tensor based on processing the first frequency tensor using a first portion of the first trained adapter; generating the frequency mask based on processing the intermediate tensor using the frequency mask generator; applying the frequency mask to the intermediate tensor to generate a masked intermediate tensor; and generating the first transformed frequency tensor based on processing the masked intermediate tensor using a second portion of the first trained adapter.

Clause 7: A method according to any of Clauses 1-6, further comprising applying an adapter weight to the intermediate tensor.

Clause 8: A method according to any of Clauses 4-7, wherein the frequency mask generator was trained to mask frequencies correlated with mode collapse in model output.

Clause 9: A method according to any of Clauses 1-8, wherein the first trained adapter comprises a frequency-domain low-rank adapter.

Clause 10: A method according to any of Clauses 1-9, further comprising generating a model output based on the fourth feature tensor, wherein the model output comprises image data.

Clause 11: A processing system comprising: a memory comprising computer-executable instructions; and one or more processors coupled to the memory and configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a first feature tensor as input to a first portion of a machine learning model;
generate a second feature tensor based on processing the first feature tensor using the first portion of the machine learning model;
generate a first frequency tensor based on processing the first feature tensor using a Fourier transform operation;
generate a first transformed frequency tensor based on processing the first frequency tensor using a first trained adapter corresponding to the first portion of the machine learning model;
generate a third feature tensor based on processing the first transformed frequency tensor using an inverse Fourier transform operation; and
generate a fourth feature tensor as output from the first portion of the machine learning model based on aggregating the second and third feature tensors.

2. The processing system of claim 1, wherein the one or more processors are configured to further execute the processor-executable instructions and cause the processing system to:
generate a second frequency tensor based on processing the first feature tensor using the Fourier transform operation;
generate a second transformed frequency tensor based on processing the second frequency tensor using a second trained adapter corresponding to the first portion of the machine learning model;
generate a fifth feature tensor based on processing the second transformed frequency tensor using the inverse Fourier transform operation; and
generate the fourth feature tensor based further on the fifth feature tensor.

3. The processing system of claim 1, wherein the one or more processors are configured to further execute the processor-executable instructions and cause the processing system to:
generate a fifth feature tensor based on processing the fourth feature tensor using a second portion of the machine learning model;
generate a second frequency tensor based on processing the fifth feature tensor using the Fourier transform operation;
generate a second transformed frequency tensor based on processing the second frequency tensor using a second trained adapter corresponding to the second portion of the machine learning model;
generate a sixth feature tensor based on processing the second transformed frequency tensor using the inverse Fourier transform operation; and
generate a seventh feature tensor as output from the second portion of the machine learning model based on aggregating the fifth and sixth feature tensors.

4. The processing system of claim 1, wherein the trained adapter comprises a frequency mask generator.

5. The processing system of claim 4, wherein the one or more processors are configured to further execute the processor-executable instructions and cause the processing system to:
generate a frequency mask, using the frequency mask generator, based on the first frequency tensor; and
generate the first transformed frequency tensor based on the frequency mask.

6. The processing system of claim 5, wherein, to generate the first transformed frequency tensor, the one or more processors are configured to execute the processor-executable instructions and cause the processing system to:
generate an intermediate tensor based on processing the first frequency tensor using a first portion of the first trained adapter;
generate the frequency mask based on processing the intermediate tensor using the frequency mask generator;
apply the frequency mask to the intermediate tensor to generate a masked intermediate tensor; and
generate the first transformed frequency tensor based on processing the masked intermediate tensor using a second portion of the first trained adapter.

7. The processing system of claim 6, wherein the one or more processors are configured to further execute the processor-executable instructions and cause the processing system to apply an adapter weight to the intermediate tensor.

8. The processing system of claim 4, wherein the frequency mask generator was trained to mask frequencies correlated with mode collapse in model output.

9. The processing system of claim 1, wherein the first trained adapter comprises a frequency-domain low-rank adapter.

10. The processing system of claim 1, wherein the one or more processors are configured to further execute the processor-executable instructions and cause the processing system to generate a model output based on the fourth feature tensor, wherein the model output comprises image data.

11. A processor-implemented method for generative machine learning, comprising:
accessing a first feature tensor as input to a first portion of a machine learning model;
generating a second feature tensor based on processing the first feature tensor using the first portion of the machine learning model;
generating a first frequency tensor based on processing the first feature tensor using a Fourier transform operation;
generating a first transformed frequency tensor based on processing the first frequency tensor using a first trained adapter corresponding to the first portion of the machine learning model;
generating a third feature tensor based on processing the first transformed frequency tensor using an inverse Fourier transform operation; and
generating a fourth feature tensor as output from the first portion of the machine learning model based on aggregating the second and third feature tensors.

12. The processor-implemented method of claim 11, further comprising:
generating a second frequency tensor based on processing the first feature tensor using the Fourier transform operation;
generating a second transformed frequency tensor based on processing the second frequency tensor using a second trained adapter corresponding to the first portion of the machine learning model;
generating a fifth feature tensor based on processing the second transformed frequency tensor using the inverse Fourier transform operation; and
generating the fourth feature tensor based further on the fifth feature tensor.

13. The processor-implemented method of claim 11, further comprising:
generating a fifth feature tensor based on processing the fourth feature tensor using a second portion of the machine learning model;
generating a second frequency tensor based on processing the fifth feature tensor using the Fourier transform operation;
generating a second transformed frequency tensor based on processing the second frequency tensor using a second trained adapter corresponding to the second portion of the machine learning model;
generating a sixth feature tensor based on processing the second transformed frequency tensor using the inverse Fourier transform operation; and
generating a seventh feature tensor as output from the second portion of the machine learning model based on aggregating the fifth and sixth feature tensors.

14. The processor-implemented method of claim 11, wherein the trained adapter comprises a frequency mask generator.

15. The processor-implemented method of claim 14, further comprising:
generating a frequency mask, using the frequency mask generator, based on the first frequency tensor; and
generating the first transformed frequency tensor based on the frequency mask.

16. The processor-implemented method of claim 15, wherein generating the first transformed frequency tensor comprises:
generating an intermediate tensor based on processing the first frequency tensor using a first portion of the first trained adapter;
generating the frequency mask based on processing the intermediate tensor using the frequency mask generator;
applying the frequency mask to the intermediate tensor to generate a masked intermediate tensor; and
generating the first transformed frequency tensor based on processing the masked intermediate tensor using a second portion of the first trained adapter.

17. The processor-implemented method of claim 16, further comprising applying an adapter weight to the intermediate tensor.

18. The processor-implemented method of claim 14, wherein the frequency mask generator was trained to mask frequencies correlated with mode collapse in model output.

19. The processor-implemented method of claim 11, further comprising generating a model output based on the fourth feature tensor, wherein the model output comprises image data.

20. A processing system comprising:
means for accessing a first feature tensor as input to a portion of a machine learning model;
means for generating a second feature tensor based on processing the first feature tensor using the portion of the machine learning model;
means for generating a frequency tensor based on processing the first feature tensor using a Fourier transform operation;
means for generating a transformed frequency tensor based on processing the frequency tensor using a trained adapter corresponding to the portion of the machine learning model;
means for generating a third feature tensor based on processing the transformed frequency tensor using an inverse Fourier transform operation; and
means for generating a fourth feature tensor as output from the portion of the machine learning model based on aggregating the second and third feature tensors.
